(19) United States
(12) Patent Application Publication
(10) Pub. No.: US 2026/0042387 A1
(43) Pub. Date: Feb. 12, 2026

(54) MULTI-PURPOSE VEHICLE-MOUNTED STORAGE DEVICE

(71) Applicant: Guangzhou Cesmai Technology Co., Ltd., Guangzhou City (CN)

(72) Inventor: Hanwei Fang, Guangzhou City (CN)

(21) Appl. No.: 19/294,315

(22) Filed: Aug. 8, 2025

(30) Foreign Application Priority Data
Aug. 8, 2024 (CN) CN202421923361.9

(51) Int. Cl. B60N 3/00

(52) U.S. Cl. CPC B60N 3/002

(57) ABSTRACT

A multi-purpose vehicle-mounted storage device includes a tray and a support member disposed on a front portion of a bottom of the tray. A first anti-slip member is disposed on a front side of the tray. A connecting portion is disposed on a rear side of the tray. A second anti-slip member is disposed on a rear portion of the bottom of the tray. When the support member is selectively secured onto a center console, the connecting portion is connected to a vehicle-mounted under-screen storage box, allowing the tray to serve as a tabletop. When the support member is selectively supported on a support beam or the vehicle-mounted under-screen storage box, the first anti-slip member rests against a rear side of a vehicle screen and the second anti-slip member rests on a dashboard, allowing the tray to serve as a storage platform.

### BACKGROUND OF THE INVENTION

### 1. Field of the Invention

The present invention relates to a vehicle-mounted storage device, and more particularly to a multi-purpose vehicle-mounted storage device.

### 2. Description of the Prior Art

Cars are indispensable in our daily lives. However, the storage space inside a car is limited. In addition to the trunk, only the storage compartments on the inner sides of the car doors, the armrest storage box between the front seats and the glove compartment in front of the front passenger seat are available for placing some items.

Chinese Patent Publication Nos. CN 202230452463.7 and CN202322024022.9 disclose under-screen storage boxes mounted on the support beam between the vehicle screen and the vehicle body for TESLA Model Y and Model 3 vehicles. The under-screen storage box includes an accommodating body and a locking unit for mounting the storage box on the support beam mounted with the vehicle screen. The storage box is secured to the support beam behind the vehicle screen. The opening of the under-screen storage box is exposed below the vehicle screen for users to place items. However, due to the limited space between the vehicle screen and the vehicle body, the storage capacity of the under-screen storage box is restricted. In general, it accommodates small-sized items. When items are too long or too thick, they cannot be placed in the under-screen storage box.

U.S. Pat. No. 11,833,948 B2 discloses a vehicle-mounted storage shelf and a vehicle using the vehicle-mounted storage shelf. The shelf comprises a storage platform and a locking member, as shown in FIGS. 1 to 7 of the above-mentioned patent. The locking member and the storage platform enclose an accommodating space that matches the support beam. Detachable fasteners are provided between the locking member and the storage platform, thereby securing the storage platform to the vehicle. In this structure, the storage platform is secured on the support beam together with the locking member, so the storage platform is secured semi-permanently behind the vehicle screen and above the support beam.

FIGS. 8 to 15 of the above-mentioned patent show another embodiment of the storage platform and the locking member. The locking member and the storage platform enclose an accommodating space that matches the support beam. The locking member is detachably connected to the storage platform, thereby securing the storage platform to the vehicle.

As shown in FIGS. 19 to 22 of the above-mentioned patent, the locking member serves as a second storage platform behind the vehicle screen, under the support beam and on the vertical surface of the dashboard assembly. In this structure, the second storage platform (the locking member) is mounted and secured on the support beam together with the original storage platform, so the storage platform is secured semi-permanently behind the vehicle screen and above the support beam.

As shown in FIG. 17, FIG. 18 and FIG. 22 of the above-mentioned patent, the bottom of the storage platform is provided with side wings. Although the storage platform does not need to be enclosed and secured to the support beam during installation, it is secured by means of the step formed on the vertical surface of the dashboard assembly and the space behind the vehicle screen. As a result, the usable surface area for placing items is relatively small, and it cannot connect the under-screen storage box with the center console to form an integrated storage platform.

Therefore, it is necessary to develop a new technical solution to solve the above problems.

### SUMMARY OF THE INVENTION

In view of the deficiencies of the prior art, the primary object of the present invention is to a provide a multi-purpose vehicle-mounted storage device, which can overcome the space limitation of the conventional vehicle-mounted under-screen storage box.

In order to achieve the above object, the present invention adopts the following technical solutions:

A multi-purpose vehicle-mounted storage device comprises a tray and a support member disposed on a front portion of a bottom of the tray. A first anti-slip member is disposed on a front side of the tray and configured for leaning against a rear side of a vehicle screen. A connecting portion is disposed on a rear side of the tray and configured for connecting with a vehicle-mounted under-screen storage box. A second anti-slip member is disposed on a rear portion of the bottom of the tray and configured for leaning against a dashboard. When the support member is selectively secured onto a center console, the connecting portion is connected to the vehicle-mounted under-screen storage box, allowing the tray to serve as a tabletop. When the support member is selectively supported on a support beam or the vehicle-mounted under-screen storage box, the first anti-slip member rests against the rear side of the vehicle screen and the second anti-slip member rests on the dashboard, allowing the tray to serve as a storage platform.

Preferably, the connecting portion has a first locking portion. The connecting portion is locked and secured to the vehicle-mounted under-screen storage box through the first locking portion.

Alternatively, the connecting portion has a first magnetic member, The connecting portion is attracted and secured to the vehicle-mounted under-screen storage box through the first magnetic member.

Preferably, the front side of the tray is recessed to form a first mounting groove. The first anti-slip member is disposed in the first mounting groove and extends out of the first mounting groove. The first anti-slip member is a silicone pad.

Preferably, the rear portion of the bottom of the tray is formed with a second mounting groove. The second anti-slip member is disposed in the second mounting groove. The second anti-slip member is a silicone support foot.

Preferably, the support member includes a support portion connected to the front portion of the bottom of the tray and a second locking portion that is movably connected to the support portion.

Preferably, a rear side of the support portion has a curved surface that matches the dashboard.

Preferably, the second locking portion is one of a slide block and a rotatable locking section.

Preferably, the vehicle-mounted under-screen storage box includes a storage body and at least one locking unit disposed at an upper end of the storage body. A mounting space is defined between the locking unit and the upper end of the storage body. The storage body is mounted on the support beam via the mounting space. The support member is selectively supported on the locking unit.

Preferably, the at least one locking unit includes two locking units on two sides of the upper end of the storage body. The two locking units each include a restricting member that is movable toward and away from the support beam. The locking units are mounted on an upper end of the support beam through the respective restricting members of the locking members. The restricting member has a restricting slot. The support member is selectively supported in the restricting slot.

Compared with the prior art, the present invention has obvious advantages and beneficial effects. Specifically, the above technical solutions reveal that:

The front side of the tray has the first anti-slip member. The rear side of the tray has the connecting portion. The front portion of the bottom of the tray has the support member. The rear portion of the bottom of the tray has the second anti-slip member. When the support member is secured to the center console, the connecting portion is connected to the vehicle-mounted under-screen storage box, allowing the tray to serve as a tabletop, thereby expanding the storage capacity of the vehicle-mounted under-screen storage box. When the support member is supported on the support beam or the vehicle-mounted under-screen storage box, the first anti-slip member rests against the rear side of the vehicle screen and the second anti-slip member rests on the dashboard, allowing the tray to serve as a storage platform, which is convenient for placing various items. The tray may serve as a tabletop or a storage platform according to the user's needs, providing convenience for placing various items. The structural design is ingenious.

Embodiments of the present invention will now be described, by way of example only, with reference to the accompanying drawings.

### BRIEF DESCRIPTION OF THE DRAWINGS

FIG. 1 is a perspective view of the multi-purpose vehicle-mounted storage device according to a first embodiment of the present invention;

FIG. 2 IS AN EXPLODED VIEW OF FIG. 1;

FIG. 3 is a perspective view of the multi-purpose vehicle-mounted storage device according to the first embodiment of the present invention when in use, wherein the tray serves as a tabletop;

FIG. 4 Is an Exploded View of FIG. 3;

FIG. 5 is a perspective view of the multi-purpose vehicle-mounted storage device according to the first embodiment of the present invention when in use, wherein the tray serves as a storage platform;

FIG. 6 is a perspective view of the multi-purpose vehicle-mounted storage device according to a second embodiment of the present invention when in use, wherein the tray serves as a tabletop;

FIG. 7 Is an Exploded View of FIG. 6; and

FIG. 8 is a perspective view of the multi-purpose vehicle-mounted storage device according to the second embodiment of the present invention when in use, wherein the tray serves as a storage platform.

### DETAILED DESCRIPTION OF THE PREFERRED EMBODIMENTS

Throughout the description of the present invention, terms such as “upper”, “lower”, “left”, and “right” are represented based on the direction of attached figures so that they may be actually different depending on the direction to which a device is arranged. It is to be understood that other specific arrangements of parts, structures, and example devices may be utilized and structural and functional modifications may be made without departing from the scope of the present invention. The support beam, the center console and the vehicle screen mentioned below are all existing technologies of the TESLA Model 3 and Model Y vehicles, and will not be described in detail.

### First Embodiment

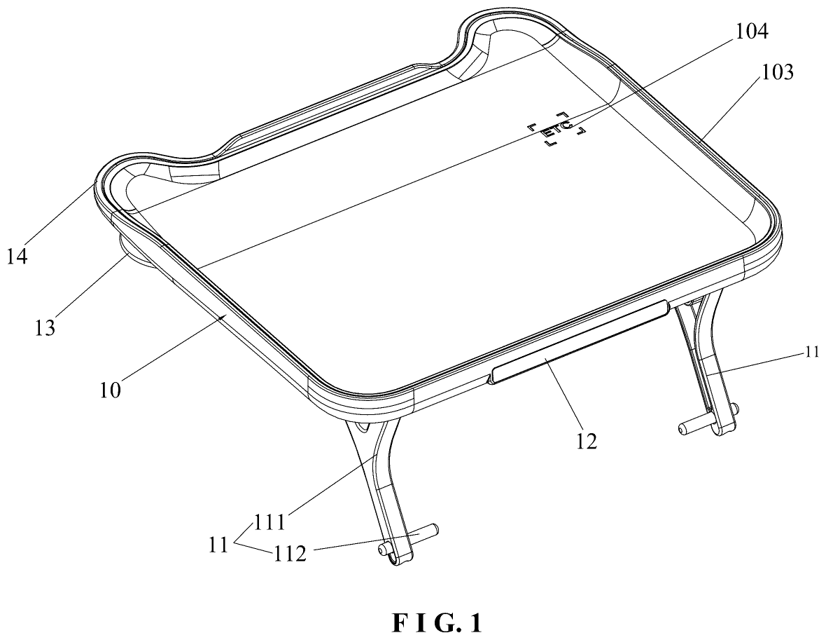

Referring to FIG. 1 through FIG. 5, a multi-purpose vehicle-mounted storage device according to a first embodiment of the present invention comprises a tray 10 and a vehicle-mounted under-screen storage box 20 mounted beneath the support beam (not shown).

A support member 11 is disposed on the front portion of the bottom of the tray 10. When in use, the support member 11 may be secured onto the center console (not shown). A first anti-slip member 12 is disposed on the front side of the tray 10. A second anti-slip member 13 is disposed on the rear portion of the bottom of the tray 10. A connecting portion 14 is disposed on the rear side of the tray 10. When the support member 11 is secured onto the center console, the user can adjust a second locking portion 112 of the support member 11 outward or inward according to the width of the center console, so as to achieve a proper fit, and the connecting portion 14 is connected to the vehicle-mounted under-screen storage box 20, allowing the tray 10 to serve as a tabletop, thereby expanding the storage capacity of the vehicle-mounted under-screen storage box 20. When the support member 11 is supported on the support beam or the vehicle-mounted under-screen storage box 20, the first anti-slip member 12 rests against the rear side of the vehicle screen (not shown), and the second anti-slip member 13 rests on the dashboard, allowing the tray 10 to serve as a storage platform.

The vehicle-mounted under-screen storage box 20 includes at least one locking unit 21 and a storage body 22. The locking unit 21 is disposed at the upper end of the storage body 22. A mounting space 202 is defined between the locking unit 21 and the upper end of the storage body 22. The vehicle-mounted under-screen storage box 20 is mounted on the support beam via the mounting space 202. The support member 11 can be supported on the locking unit 21. The at least one locking unit 21 includes two locking units on both sides of the upper end of the storage body 22. The two locking units 21 each include a restricting member 211 that is movable toward and away from the support beam. The locking unit 21 is mounted on the upper end of the support beam through the restricting member 211. The restricting member 211 has a restricting slot 212. The second locking portion 112 can be selectively moved outward or inward according to the width of the support beam for the support member 11 to be supported in the restricting slot 212.

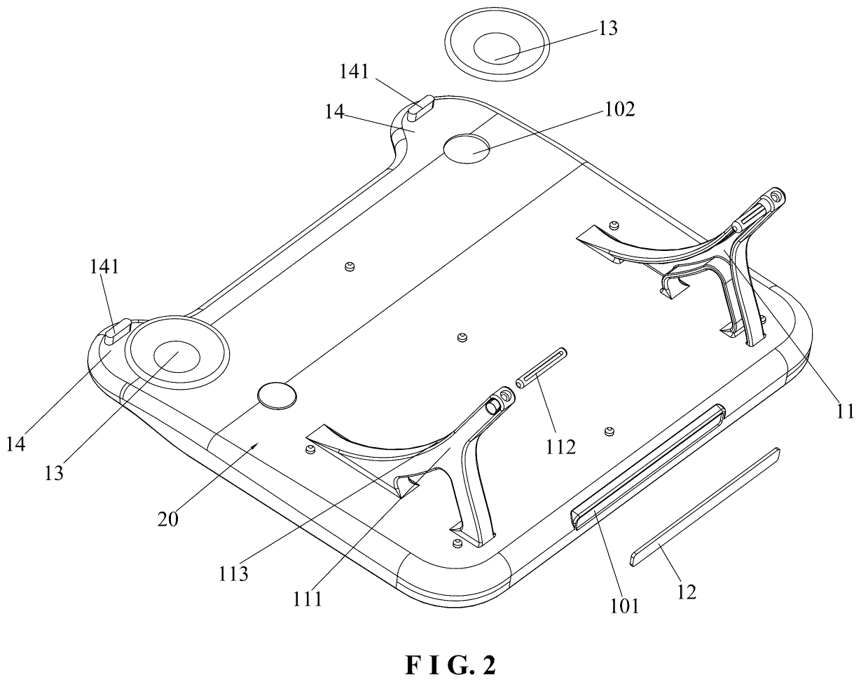

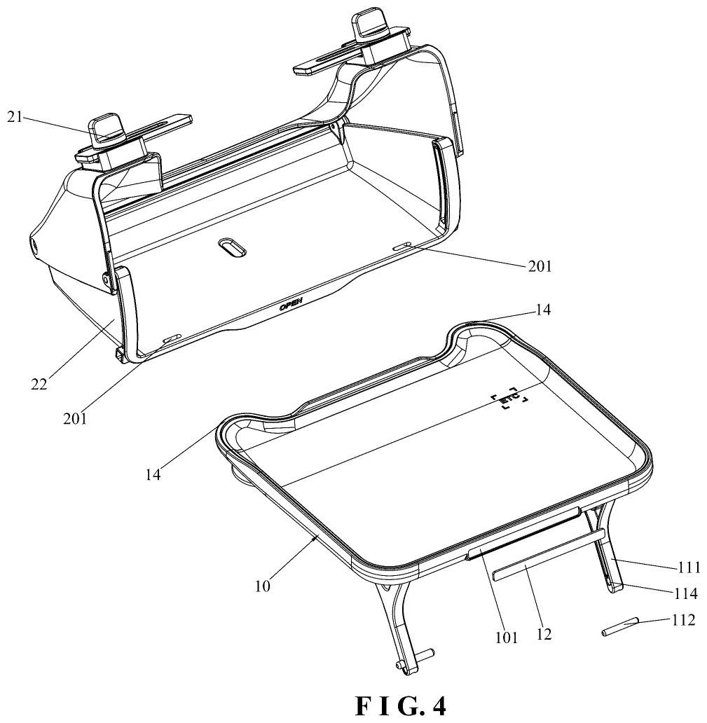

Referring to FIG. 2 and FIG. 4, the connecting portion 14 has a first locking portion 141, and the storage body 22 has a mating portion 201 that matches the first locking portion 141. The first locking portion 141 can be locked into the mating portion 201 so that the tray 10 is secured to the storage body 22. Specifically, two spaced mating portions 201 and two spaced connecting portions 14 are provided in this embodiment. The mating portions 201 and the first locking portions 141 prevent the tray 10 from detaching from the storage body 22 when the tray 10 serves as a tabletop. The first locking portion 141 may be a locking protrusion on the bottom of the connecting portion 14. The mating portion 201 may be a locking groove matching the locking protrusion.

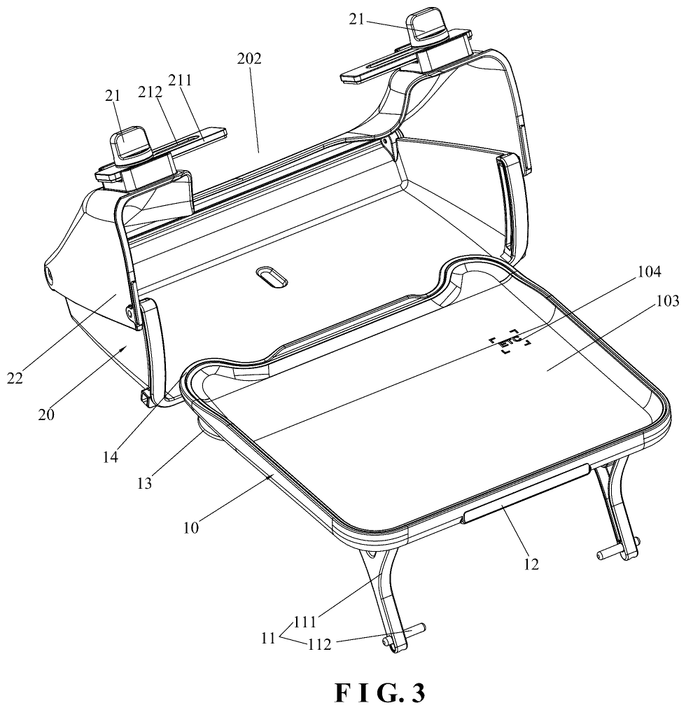

Referring to FIG. 3, the front side of the tray 10 is recessed to form a first mounting groove 101. The first anti-slip member 12 is disposed in the first mounting groove 101 and extends out of the first mounting groove 101. The first anti-slip member 12 is a silicone pad. The first mounting groove 101 is located in the middle of the front side of the tray 10. The rear portion of the bottom of the tray 10 is formed with a second mounting groove 102. The second anti-slip member 13 is disposed in the second mounting groove 102. The second anti-slip member 13 is a silicone support foot. Specifically, two spaced second mounting grooves 102 and two spaced second anti-slip members 13 are provided in this embodiment. The first anti-slip member 12 is located between the two second anti-slip members 13.

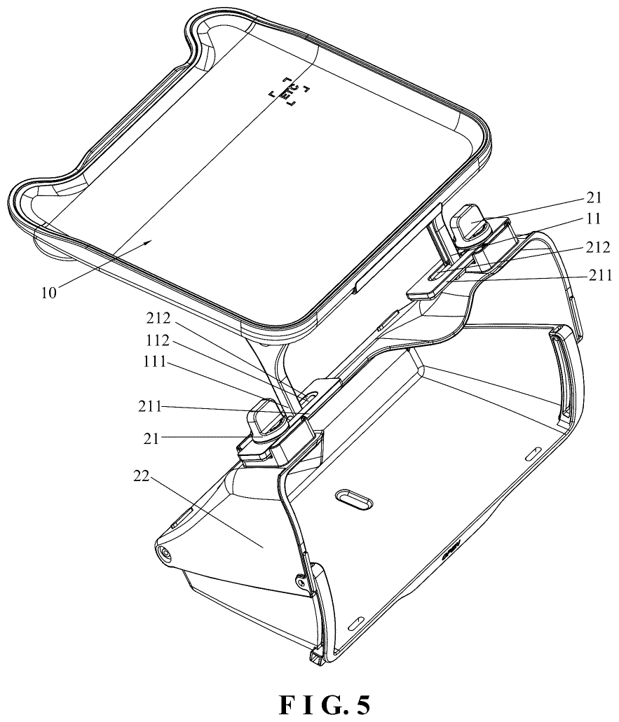

Referring to FIG. 2 and FIG. 5, the support member 11 includes a support portion 111 connected to the front portion of the bottom of the tray 10 and a second locking portion 112 that is movably connected to the support portion 111. The rear side of the support portion 111 has a curved surface 113 that matches the dashboard. The opposite sides of the support portions 111 of the two support members 11 each have a first mounting hole 114. The second locking portion 112 is slidably connected in the first mounting hole 114. The second locking portion 112 is a slide block. When the bottom end of the support portion 111 is confined in the restricting groove 212, the second locking portion 112 can be moved according to the required width to be located in the restricting groove 212. Preferably, the support member 11 is integrally connected to the front portion of the bottom of the tray 10.

The tray 10 has a shallow platform 103. An ETC (electronic toll collection) sensor placement position 104 may be disposed on the shallow platform 103. A magnet is fixed in the ETC placement position 104. A silicone pad is attached to the shallow platform 103. The silicone pad covers the magnet.

### Second Embodiment

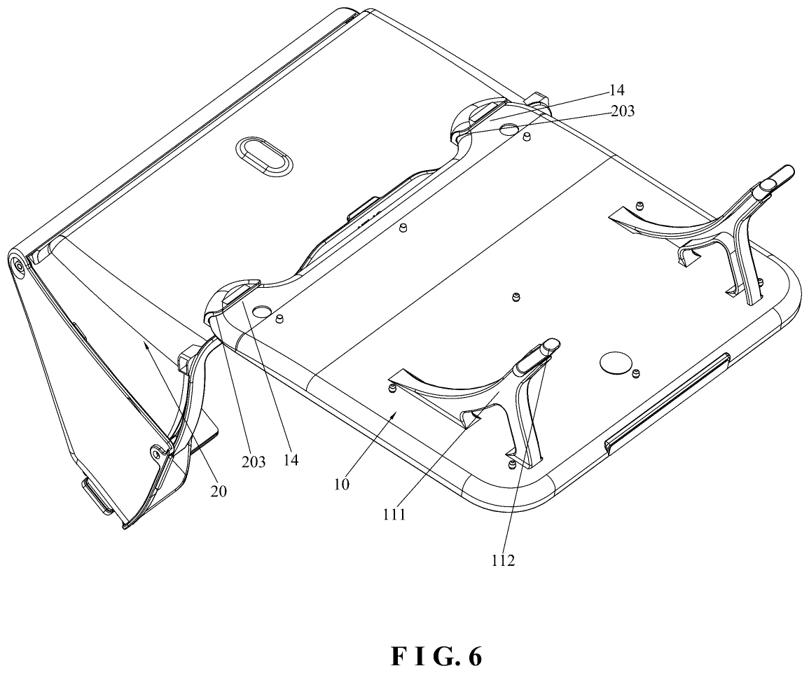

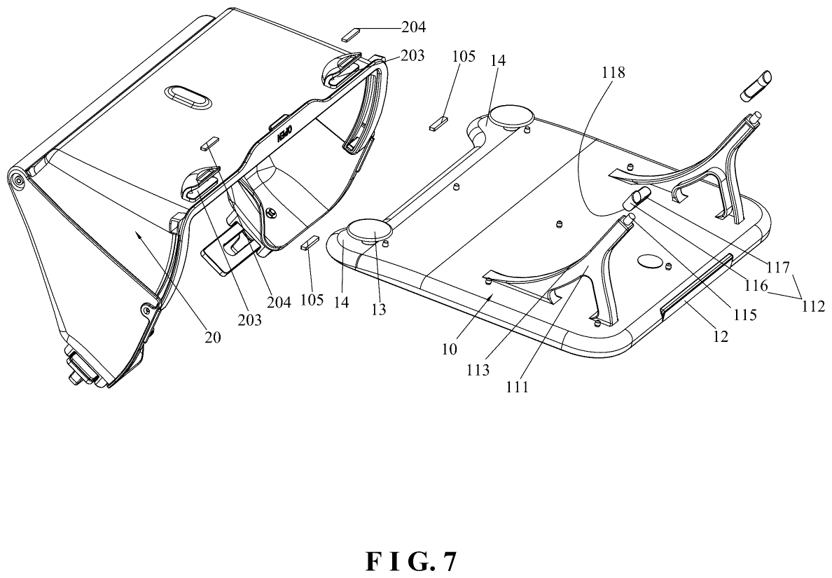

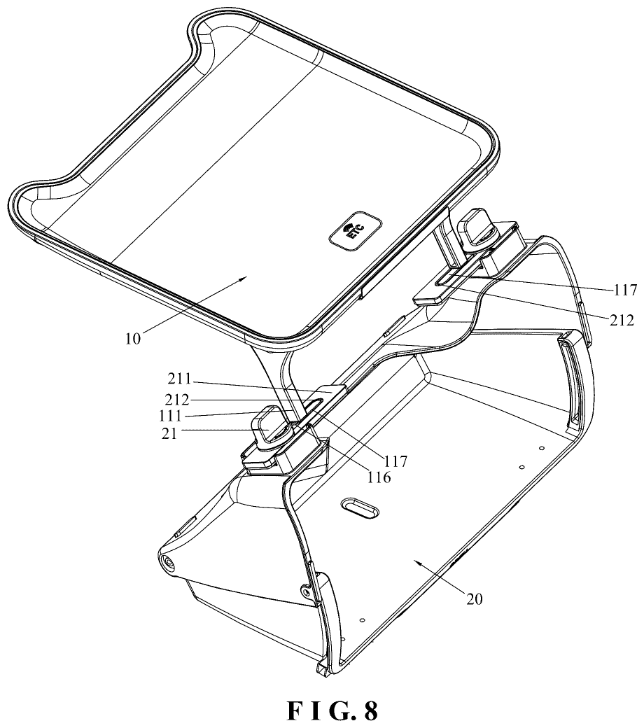

FIGS. 6 to 8 illustrate a second embodiment of the present invention. The second embodiment is substantially similar to the first embodiment with the exceptions described hereinafter.

The lower end of the storage body 22 has a receiving groove 203. A first magnetic member 204 is provided in the receiving groove 203. The connecting portion 14 has a second magnetic member 105 that matches the first magnetic member 204. The connecting portion 14 is inserted in the receiving groove 203 and secured in place through the magnetic attraction between the first magnetic member 204 and the second magnetic member 105. The first magnetic member 204 and the second magnetic member 105 may be both magnets, alternatively, one of them is a magnet and the other is an iron member.

The bottom ends of the support portions 111 of the two support members 11 each have a mounting post 115. The second locking portion 112 includes a support section 116 and a locking section 117 extending from the support section 116. The support section 116 has a second mounting hole 118 that matches the mounting post 115. The support section 116 is insertedly connected to the support portion 111 through cooperation between the second mounting hole 118 and the mounting post 115. The locking section 117 is rotatable relative to the mounting post 115. The support section 116 is confined by the restricting groove 212. The locking section 117 can be rotated as desired to be located in the restricting groove 212.

The features of the present invention are described below.

The front side of the tray has the first anti-slip member. The rear side of the tray has the connecting portion. The front portion of the bottom of the tray has the support member. The rear portion of the bottom of the tray has the second anti-slip member.

When the support member is secured to the center console, the connecting portion is connected to the vehicle-mounted under-screen storage box, allowing the tray to serve as a tabletop, thereby expanding the storage capacity of the vehicle-mounted under-screen storage box. When the support member is supported on the support beam or the vehicle-mounted under-screen storage box, the first anti-slip member rests against the rear side of the vehicle screen, and the second anti-slip member rests on the dashboard, allowing the tray to serve as a storage platform, which is convenient for placing various items. The tray may serve as a tabletop or a storage platform according to the user's needs, providing convenience for placing various items. The structural design is ingenious.

The second locking portion of the support member plays a crucial role in allowing the support member to effectively adjust its vertical height and horizontal width to reach the support beam or center console in different vehicle models, which is the important spirit of the present invention.

What is claimed is:

1. A multi-purpose vehicle-mounted storage device, comprising a tray and a support member disposed on a front portion of a bottom of the tray;
a first anti-slip member being disposed on a front side of the tray and configured for leaning against a rear side of a vehicle screen, a connecting portion being disposed on a rear side of the tray and configured for connecting with a vehicle-mounted under-screen storage box, a second anti-slip member being disposed on a rear portion of the bottom of the tray and configured for leaning against a surface of a dashboard;
wherein when the support member is selectively secured onto a center console, the connecting portion is connected to the vehicle-mounted under-screen storage box, allowing the tray to serve as a tabletop;
wherein when the support member is selectively supported on a support beam or the vehicle-mounted under-screen storage box, the first anti-slip member rests against the rear side of the vehicle screen and the second anti-slip member rests on the dashboard, allowing the tray to serve as a storage platform.

2. The multi-purpose vehicle-mounted storage device as claimed in claim 1, wherein the connecting portion has a first locking portion, and the connecting portion is locked and secured to the vehicle-mounted under-screen storage box through the first locking portion.

3. The multi-purpose vehicle-mounted storage device as claimed in claim 1, wherein the connecting portion has a first magnetic member, and the connecting portion is attracted and secured to the vehicle-mounted under-screen storage box through the first magnetic member.

4. The multi-purpose vehicle-mounted storage device as claimed in claim 1, wherein the front side of the tray is recessed to form a first mounting groove, the first anti-slip member is disposed in the first mounting groove and extends out of the first mounting groove, and the first anti-slip member is a silicone pad.

5. The multi-purpose vehicle-mounted storage device as claimed in claim 1, wherein the rear portion of the bottom of the tray is formed with a second mounting groove, the second anti-slip member is disposed in the second mounting groove, and the second anti-slip member is a silicone support foot.

6. The multi-purpose vehicle-mounted storage device as claimed in claim 1, wherein the support member includes a support portion connected to the front portion of the bottom of the tray and a second locking portion that is movably connected to the support portion.

7. The multi-purpose vehicle-mounted storage device as claimed in claim 6, wherein a rear side of the support portion has a curved surface that matches the dashboard.

8. The multi-purpose vehicle-mounted storage device as claimed in claim 6, wherein the second locking portion is one of a slide block and a rotatable locking section.

9. The multi-purpose vehicle-mounted storage device as claimed in claim 1, wherein the vehicle-mounted under-screen storage box includes a storage body and at least one locking unit disposed at an upper end of the storage body, a mounting space is defined between the locking unit and the upper end of the storage body, the storage body is mounted on the support beam via the mounting space, and the support member is selectively supported on the locking unit.

10. The multi-purpose vehicle-mounted storage device as claimed in claim 9, wherein the at least one locking unit includes two locking units on two sides of the upper end of the storage body, the two locking units each include a restricting member that is movable toward and away from the support beam, the locking units are mounted on an upper end of the support beam through the respective restricting members of the locking members, the restricting member has a restricting slot, and the support member is selectively supported in the restricting slot.
